(19) United States
(12) Patent Application Publication
(10) Pub. No.: US 2006/0158417 A1
(43) Pub. Date: Jul. 20, 2006

(54) PLASMA DISPLAY APPARATUS AND DRIVING METHOD THEREOF

(75) Inventor: Jeong Pil Choi, Suwon-si (KR)

Correspondence Address: FISH & RICHARDSON P.C., P.O. BOX 1022, MINNEAPOLIS, MN, 55440-1022, US

(73) Assignee: LG Electronics Inc., Youngdungpo-gu (KR)

(21) Appl. No.: 11/275,548

(22) Filed: Jan. 13, 2006

(30) Foreign Application Priority Data
Jan. 18, 2005 (KR) 10-2005-0004745
Mar. 30, 2005 (KR) 10-2005-0026744

(51) Int. Cl. G09G 3/36

(52) U.S. Cl. 345/99

(57) ABSTRACT

The present invention relates to plasma display apparatus and method of driving the same. In a plasma display apparatus and driving method thereof in accordance with an embodiment of the present invention a driving pulse corresponding to an image data inputted through one input terminal is outputted to m output channels. A plasma display apparatus and driving method thereof allows changes of fan-out of an electrode driver without any change of construction of the electrode driver, and enables to reduce costs and time required for designing and developing an electrode driver optimized to a specific size plasma display device.

This non-provisional application claims priority under 35 U.S.C. §119(a) on Patent Application No.10-2005-0004745 and 10-2005-0026744 filed in Korea on Jan. 18, 2005 and on Mar. 30, 2005 the entire contents of which are hereby incorporated by reference.

### BACKGROUND OF THE INVENTION

1. Field of the Invention

The document relates to plasma display apparatus and driving method thereof.

2. Description of the Related Art

In a general plasma display apparatus, an image signal inputted externally undergoes a subfield mapping process to adjust driving of the plasma display apparatus, and then, the mapped data is re-arrayed by subfields for gray scale processing.

When a scan pulse is applied to a scan electrode of the plasma display apparatus, an address pulse corresponding to an image data as re-arrayed by subfields is applied to an address electrode, whereby a cell is selected.

Then, if a sustain pulse is applied to scan electrode and sustain electrode, the selected cell maintains to discharge, and the plasma display apparatus displays an image.

A general plasma display device comprises an electrode driver for supplying driving pulse to scan electrode, sustain electrode, and address electrode. With increases of resolution as well as of size of a plasma display device, fan-out of an electrode driver becomes a significant problem.

In other words, if a plasma display device becomes bigger-sized, and/or supports full High Definition image quality, it becomes problematic that one single type of electrode driver drives all the plasma display devices of different sizes. Thus, if a data driver optimized to a plasma display device of a specific size is applied to a large-sized plasma display device, fan-out of the electrode driver can be insufficient

As a result in order to develop an electrode driver appropriate for adoption to a large-sized plasma display device, electrode drivers each optimized to a different size plasma display device shall be designed, which process causes rise of the manufacture costs.

### SUMMARY OF THE INVENTION

Accordingly, an object of the present invention is to solve at least the problems and disadvantages of the background art

An embodiment of the present invention aims to provide a plasma display device capable of controlling the fan-out of an electrode driver regardless of the size of a plasma display device, and a method of driving the same.

An embodiment of the present invention aims to provide a plasma display device which enables to reduce costs and time required for designing and developing an electrode driver suitable for a specific size plasma display device, and a method of driving the same.

A plasma display device in accordance with an embodiment of the present invention comprises an electrode driver for outputting a plurality of driving pulses of the same level through m output terminals of all of output terminals upon the input of a mode setting signal and a plasma display panel on which a plurality of electrodes are formed, wherein the plurality of driving pulses are supplied to one of the plurality of electrodes.

A plasma display device in accordance with an embodiment of the present invention comprises a shift register for allocating an image data inputted through one input terminal to m output terminals simultaneously upon the input of a mode setting signal, a latch for loading the image data from the m output terminals of the shift register to m input terminals of the latch simultaneously and outputs the image data to m output terminals of the latch, a switching driver for outputting a plurality of driving pulses based on the image data inputted from the m output terminals of the latch and a plasma display panel on which a plurality of electrodes are formed, wherein the plurality of driving pulses are supplied to one of the plurality of electrodes.

A method of driving a plasma display in accordance with an embodiment of the present invention comprises allocating image data inputted through one input terminal to m output terminals simultaneously upon the input of a mode setting signal, loading and outputting the image data allocated to the m output terminals simultaneously and supplying a driving pulse to one of the plurality of electrodes based on the image data.

A plasma display device in accordance with an embodiment of the present invention allows changes of fan-out of an electrode driver without any change of construction of the electrode driver.

A plasma display device in accordance with an embodiment of the present invention enables to reduce costs and time required for designing and developing an electrode driver optimized to a specific size plasma display device.

### BRIEF DESCRIPTION OF THE DRAWINGS

The embodiments of the invention will be described in detail with reference to the following drawings in which like numerals refer to like elements.

FIG. 1 shows a plasma display apparatus in accordance with an embodiment of the present invention.

FIG. 2 is a drawing showing the operations of a data driver in accordance with an embodiment of the present invention.

FIG. 3 is a drawing showing the driving method of a plasma display apparatus in accordance with an embodiment of the present invention.

FIG. 4 is a block diagram of a data driver in a plasma display apparatus in accordance with an embodiment of the present invention.

FIG. 5 is a drawing showing the operations of a data driver according to an embodiment of the present invention in the absence of a mode setting signal.

FIG. 6 is a drawing showing the driving method of a plasma display apparatus in accordance with an embodiment of the present invention in the absence of a mode setting signal.

FIG. 7 is a block diagram of a data driver in a plasma display apparatus in accordance with an embodiment of the present invention in the absence of a mode setting signal.

### DETAILED DESCRIPTION OF PREFERRED EMBODIMENTS

Embodiments of the present invention will be described in a more detailed manner with reference to the drawings.

A plasma display apparatus in accordance with an embodiment of the present invention comprises an electrode driver for outputting a plurality of driving pulses of the same level through m output terminals of all of output terminals upon the input of a mode setting signal and a plasma display panel on which a plurality of electrodes are formed, wherein the plurality of driving pulses are supplied to one of the plurality of electrodes.

The plurality of electrodes are a plurality of address electrodes, and the electrode driver is an address electrode driver for supplying the plurality of driving pulses to the plurality of address electrodes.

The electrode driver outputs a driving pulse through one of all of the output terminals if no mode setting signal is inputted, and the driving pulse is supplied to one of the plurality of electrodes.

m is equal to 2.

A plasma display device in accordance with an embodiment of the present invention comprises a shift register for allocating an image data inputted through one input terminal to m output terminals simultaneously upon the input of a mode setting signal, a latch for loading the image data from the m output terminals of the shift register to m input terminals of the latch simultaneously and outputs the image data to m output terminals of the latch, a switching driver for outputting a plurality of driving pulses based on the image data inputted from the m output terminals of the latch and a plasma display panel on which a plurality of electrodes are formed, wherein the plurality of driving pulses are supplied to one of the plurality of electrodes.

The plurality of electrodes are a plurality of address electrodes, and the electrode driver is an address electrode driver for supplying the plurality of driving pulses to the plurality of address electrodes.

The shift register allocates the image data inputted through one input terminal of the shift register to one output terminal of the shift register when no mode setting signal is inputted, the latch loads the image data from the one output terminal of the shift register to one input terminal of the latch and outputs the image data to one output terminal of the latch, and the switching driver outputs a driving pulse based on the image data inputted from the one output terminals of the latch.

The driving pulse is outputted for x/(n x m) clocks or more when the input terminals and output terminals of the shift register are n and x, respectively.

m is equal to 2.

A method of driving a plasma display apparatus comprising a plurality of electrodes in accordance with an embodiment of the present invention comprises allocating image data inputted through one input terminal to m output terminals simultaneously upon the input of a mode setting signal, loading and outputting the image data allocated to the m output terminals simultaneously and supplying a driving pulse to one of the plurality of electrodes based on the image data.

The image data inputted from the one input terminal is allocated to one output terminal when no mode setting signal is inputted.

m is equal to 2.

The driving pulse is an address pulse, and the plurality of electrodes are a plurality of address electrodes.

A plasma display device in accordance with an embodiment of the present invention allows changes of fan-out of an electrode driver without any change of construction of the electrode driver.

A plasma display device in accordance with an embodiment of the present invention enables to reduce costs and time required for designing and developing an electrode driver optimized to a specific size plasma display device.

A detailed description of preferred embodiments of the present invention is given below making reference to the accompanying drawings.

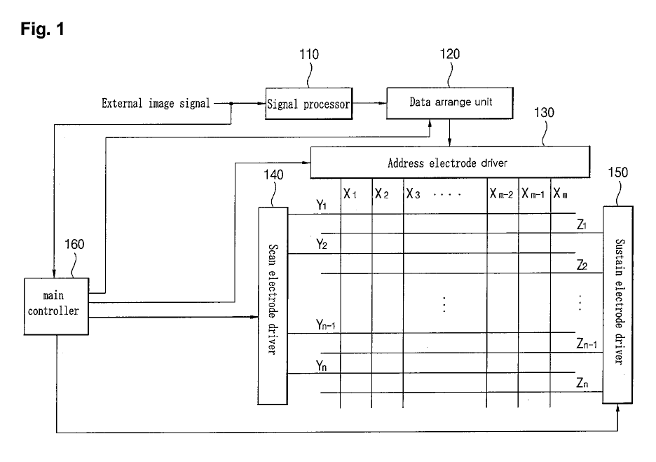

FIG. 1 shows a plasma display apparatus in accordance with an embodiment of the present invention. As shown in FIG. 1, a plasma display apparatus according to an embodiment of the present invention comprises a signal processor 110, a data arrange unit 120, an address electrode driver 130, a scan electrode driver 140, a sustain electrode driver 150, and a main controller 160.

The signal processor 110 transforms externally inputted image signals into image data compatible to a plasma display apparatus by conducting processes of reverse-gamma compensation, gain adjustment, half-toning, and subfield-mapping.

The data arrange unit 120 re-arrays the image data as transformed and mapped into subfields through signal processor 110 by subfield for gray scale processing.

The address electrode driver 130 supplies address pulse corresponding to the data as re-arrayed by subfield through the data arrange unit 120 to address electrodes (X1 to Xm) by lines.

The scan electrode driver 140 supplies scan pulse for equalizing electric charge in cells and for selecting cells as well as sustain pulse for maintaining discharge in selected cells to scan electrodes (Y1 toYn).

The sustain electrode driver 150 supplies sustain pulse for maintaining discharge in selected cells to sustain electrodes (Z1 to Zn).

The main controller 160 controls the data arrange unit 120 to supply the image data as re-arrayed from external image signals to the address electrode driver 130, and controls switching operations of the address electrode driver 130, of the scan electrode driver 140, and of the sustain electrode driver 150.

At least one of the address electrode driver 130, the scan electrode driver 140, and the sustain electrode driver 150 comprises an electrode driver. An electrode driver according to an embodiment of the present invention supplies a plurality of driving pulses of the same level through m channels (m stands for the natural number 2 or up).

An electrode driver according to an embodiment of the present invention can also supply driving pulse to one electrode formed by combinations ofm output channels.

An electrode driver according to an embodiment of the present invention can also supply driving pulse of a same level through m channels based on the presence of a mode setting signal inputted from the main controller 160. In other words, the electrode driver supplies one driving pulse through one output channel when no mode setting signal inputted from the main controller 160 is present, and, in contrast, the electrode driver supplies the plurality of driving pulses of the same level to m output channels when a mode setting signal inputted from the main controller 160 is present

An electrode driver according to an embodiment of the present invention supports m times fan-out by supplying the plurality of driving pulses of the same level through m output channels.

The address electrode driver according to an embodiment of the present invention comprises a data driver for supplying address pulse to address electrodes.

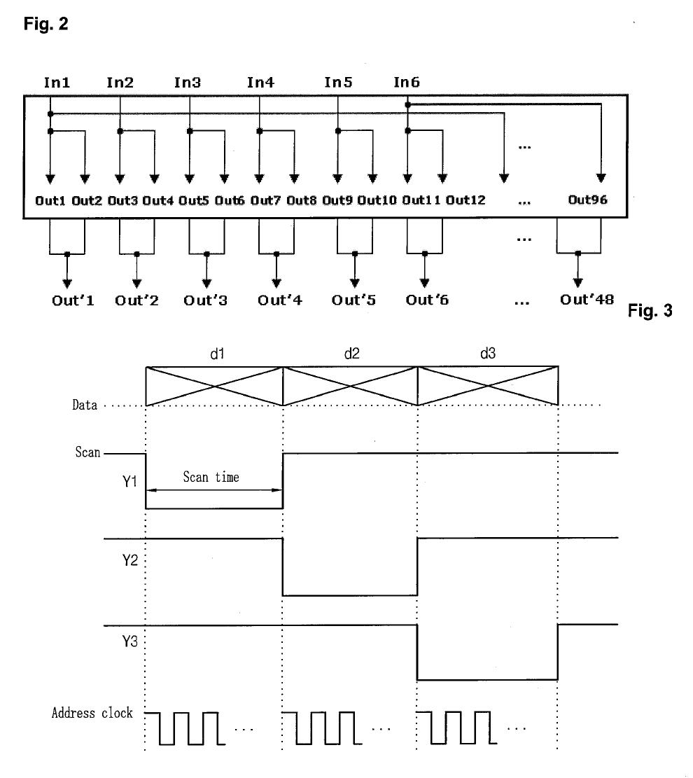

FIG. 2 is a drawing showing the operations of a data driver in accordance with an embodiment of the present invention. As shown in FIG. 2, a data driver according to an embodiment of the present invention supplies address pulse corresponding to image data inputted through one input terminal to m (m stands for the natural number 2 or up) output channels simultaneously. In FIG. 2, m is equal to 2.

In other words, the data driver outputs address pulse corresponding to the image data inputted through the 1st input terminal (In1) through the 1st output channel (Out1) and the 2nd output channel (Out2), and outputs address pulse corresponding to the image data inputted through the 2nd input terminal (In2) through the 3rd output channel (Out3) and the 4th output channel (Out4). In this manner, the data driver outputs address pulse corresponding to image data inputted through the 3rd to 6th input channels (In3 to In6) through the 5th and 6th output channels (Out5, Out6), through the 7th and 8th output channels (Out7, Out8), through the 9th and 10th output channels (Out9, OutlO), and through the 11th and 12th output channels (Outll, Outl2), respectively.

After the image data have been inputted through the first input terminal (In1) to the sixth input terminal (In6), the image data is inputted through the first input terminal again, and then, address pulse corresponding to the image data inputted through the first input terminal (In1) is outputted through the 13^{th} output channel (Outl3) and the 14^{th} output channel (Outl4).

Finally, the electrode driver outputs address pulse corresponding to the image data inputted through the 6^{th} input terminal (In6) through the 95^{th} output channel (Out95) and the 96^{th} ( output channel (Out96).

An electrode driver according to an embodiment of the present invention can also supply address pulse to one address electrode formed by combinations of m output channels. For example, address pulse can be supplied to one address electrode (Out′1) which is formed by combination of the first output terminal (Out1) and the second output terminal (Out2), when m=2.

FIG. 3 is a drawing showing the driving method of a plasma display apparatus in accordance with an embodiment of the present invention. As shown in FIG. 3, the data driver receives data from the data arrange unit in FIG. 1 through n input terminals (n is a natural number) and supplies address pulse to address electrode connected to output terminals of the data driver.

The data driver has to supply address pulse to all output terminals thereof during one address clock. Thus, if the data driver outputs address pulse corresponding to the data received from one input terminal through m output terminals simultaneously, the number of required address clock is x/(n x m) or more. Here, x stands for the total number of output terminals of the data driver. Therefore, when the number of data driver is y, the number of required address clock is xy/(n x m) or more, and the scan time corresponding to the width of one scan pulse is same as or longer than the time for xy/(n x m) address clocks.

For example, the data driver in FIG. 2 receives data from the data arrange unit 120 through six input terminals (in1 to in6) and supplies address pulse to the address electrodes (Out′1 to Out′48) connected to the output terminals (Out1 to Out96) ofthe data driver.

The data driver in FIG. 2 has to supply address pulse to all output terminals (Out1 to Out96) of the data driver during one address clock. Thus, if the data driver outputs address pulse corresponding to the data received from one input terminal through two output terminals simultaneously, the number of required address pulse is 8 (=96/6×2) or more. Therefore, when the number of data driver is 10, the number of required address clock is 80 (=8×10) or more, and the scan time is same as 80 or more address clocks, or longer.

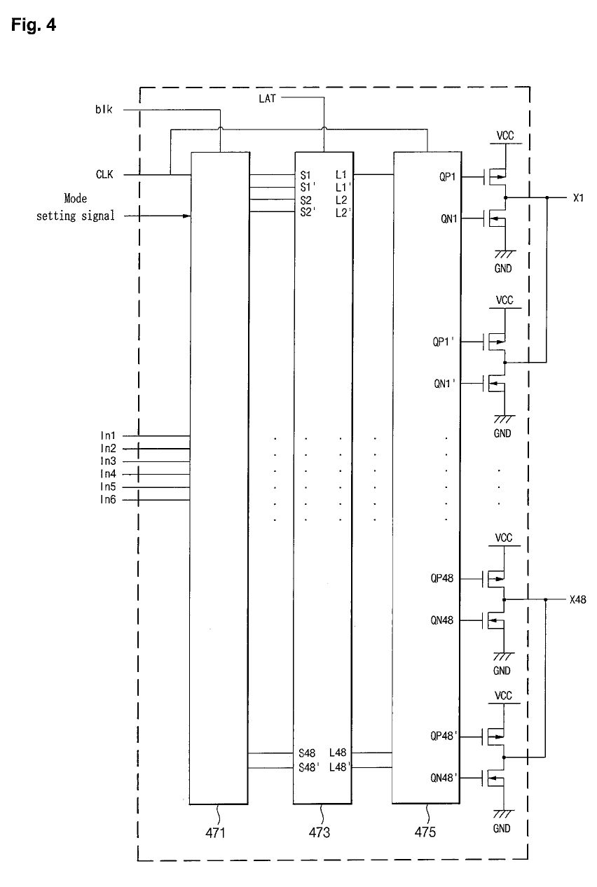

FIG. 4 is a block diagram of a data driver in a plasma display apparatus in accordance with an embodiment of the present invention. As shown in FIG. 4, the data driver comprises a shift register 471, a latch 473, and a switch driver 475.

The shift register 471 allocates image data inputted through one input terminal to m output terminals simultaneously, and arrays into x bit data, when a mode setting signal is inputted. In FIG. 4, m is 2 and x is 96. The shift register 471 outputs x bit data to input terminals ofthe latch 473 based on latch signals(LAT).

The latch 473, being consisted of x input terminals, loads data of the bits to m input terminals simultaneously. For example, if x is 96 and m is 2, the latch 473 is consisted of 96 input terminals and loads data of the bits to two input terminals (S1 and S1′, S2 and S2′, S3 and S3′, . . . , S48 and S48′) simultaneously.

The switch driver 475 outputs driving pulse by driving the switches based on the data inputted from the latch 473.

Then, an address pulse corresponding to the data inputted to one input terminal of the shaft register 471 is outputted to m output channels simultaneously. Here, the data driver can support m-fold fan-out when m output pins are combined to one address electrode.

In the absence of a mode setting signal, the data driver supplies address pulse corresponding to the data inputted from one output terminal to address electrode through one output channel.

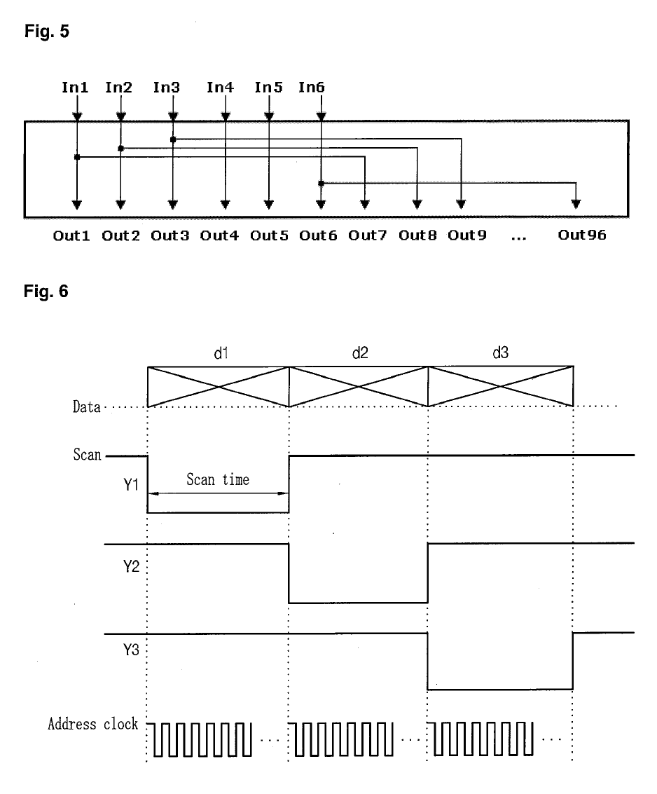

FIG. 5 is a drawing showing the operations of a data driver according to an embodiment of the present invention in the absence of a mode setting signal. As shown in FIG. 5, the data driver according to an embodiment of the present invention supplies address pulse corresponding to the data inputted from one output terminal to address electrode through one output channel, in the absence of a mode setting signal.

In other words, the data driver outputs address pulse corresponding to image data inputted from the 1^{st} input terminal (In1) through the 1^{st} output channel (Out1), address pulse corresponding to image data inputted from the 2^{nd} input terminal (In2) through the 2^{nd} output channel (Out2). In this manner, the data driver outputs address pulse corresponding to image data inputted from the 3^{rd} to 6^{th} input terminals (ln3 to in6) through the 3rd output channel (Out3), the 4^{th} output channel (Out4), the 5^{th} output channel (Out5), and the 6^{th} output channel (Out6), respectively.

After the image data have been inputted through the 1^{st} input terminal (In1) to the 6th input terminal (In6), the image data is inputted through the 1st input terminal again, and then, address pulse corresponding to the image data inputted through the 1st input terminal (In1) is outputted through the 7^{th} output channel (Out7).

In the absence of a mode setting signal, output channels of the electrode driver are connected to one address electrode.

FIG. 6 is a drawing showing the driving method of a plasma display apparatus in accordance with an embodiment of the present invention in the absence of a mode setting signal. As shown in FIG. 6, the data driver receives data from data arrange unit 120 in FIG. 1 through n input terminals (n stands for a natural number) and supplies address pulse to address electrodes connected to the output terminals of the data driver.

The data driver has to supply address pulse to all output terminals of the data driver during one address clock. Thus, in the absence of a mode setting signal, as the data driver outputs address pulse corresponding to data inputted from one input terminal through one output terminal simultaneously, the number of required address pulse is x/n or more. Here x stands for the total number of output terminals of the data driver.

Therefore, when the number of data driver is y, the number of required address clock is xy/n or more, and the scan time is same as or longer than the time for application of xy/n address clocks.

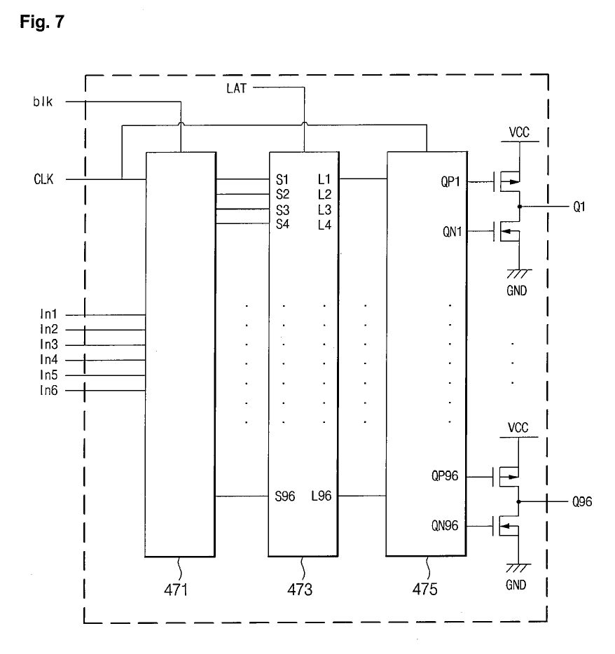

FIG. 7 is a block diagram of a data driver in a plasma display apparatus in accordance with an embodiment of the present invention in the absence of a mode setting signal. As shown in FIG. 7, the data driver comprises a shift register 471, a latch 473, and a switch driver 475.

The shift register 471 allocates image data inputted through one input terminal to one output terminal, and arrays into x bit data, when no mode setting signal is inputted. In FIG. 7, x is 96. The shift register 471 outputs x bit data to input terminals of the latch 473 based on latch signals (LAT).

The latch 473, being consisted of x input terminals, loads data of the bits to one input terminal.

The switch driver 475 outputs switch driving pulse based on the data inputted from the latch 473.

Then, an address pulse corresponding to the data inputted to one input terminal of the shaft register 471 is outputted to one output channel.

As shown in FIGS. 4 and 7, an electrode driver in accordance with an embodiment of the present invention can increase fan-out of an electrode driver based on the presence or absence of a mode setting signal without any change of construction of the electrode driver. That is, a plasma display apparatus according to an embodiment of the present invention can increase the fan-out to m-fold by outputting address pulse corresponding to image data inputted from one input terminal through m output channels, when a mode setting signal is present.

Therefore, there is no need for a change of construction of an electrode driver dependent on the size of a plasma display apparatus.

The embodiments of invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus comprising:
an electrode driver for outputting a plurality of driving pulses of the same level through m output terminals of all of output terminals upon the input of a mode setting signal; and
a plasma display panel on which a plurality of electrodes are formed, wherein the plurality of driving pulses are supplied to one of the plurality of electrodes.

2. The plasma display apparatus as claimed in claim 1, wherein the plurality of electrodes are a plurality of address electrodes, and
the electrode driver is an address electrode driver for supplying the plurality of driving pulses to the plurality of address electrodes.

3. The plasma display apparatus as claimed in claim 1, wherein the electrode driver outputs a driving pulse through one of all of the output terminals if no mode setting signal is inputted, and the driving pulse is supplied to one of the plurality of electrodes.

4. The plasma display apparatus as claimed in claim 1, wherein m is equal to 2.

5. A plasma display apparatus comprising:
a shift register for allocating an image data inputted through one input terminal to m output terminals simultaneously upon the input of a mode setting signal;
a latch for loading the image data from the m output terminals of the shift register to m input terminals of the latch simultaneously and outputs the image data to m output terminals of the latch;
a switching driver for outputting a plurality of driving pulses based on the image data inputted from the m output terminals of the latch; and
a plasma display panel on which a plurality of electrodes are formed, wherein the plurality of driving pulses are supplied to one of the plurality of electrodes.

6. The plasma display apparatus as claimed in claim 5, wherein the plurality of electrodes are a plurality of address electrodes, and
the electrode driver is an address electrode driver for supplying the plurality of driving pulses to the plurality of address electrodes.

7. The plasma display apparatus as claimed in claim 5, wherein the shift register allocates the image data inputted through one input terminal of the shift register to one output terminal of the shift register when no mode setting signal is inputted,
the latch loads the image data from the one output terminal of the shift register to one input terminal of the latch and outputs the image data to one output terminal of the latch, and
the switching driver outputs a driving pulse based on the image data inputted from the one output terminals of the latch.

8. The plasma display apparatus as claimed in claim 5, wherein the driving pulse is outputted for x/(n x m) clocks or more when the input terminals and output terminals of the shift register are n and x, respectively.

9. The plasma display apparatus as claimed in claim 5, wherein m is equal to 2.

10. A method of driving a plasma display apparatus comprising a plurality of electrodes comprising:
allocating image data inputted through one input terminal to m output terminals simultaneously upon the input of a mode setting signal;
loading and outputting the image data allocated to the m output terminals simultaneously; and
supplying a driving pulse to one of the plurality of electrodes based on the image data.

11. The method as claimed in claim 10, wherein the image data inputted from the one input terminal is allocated to one output terminal when no mode setting signal is inputted.

12. The method as claimed in claim 10, wherein m is equal to 2.

13. The method as claimed in claim 10, wherein the driving pulse is an address pulse, and the plurality of electrodes are a plurality of address electrodes.
